(19) United States
(12) Patent Application Publication
(10) Pub. No.: US 2024/0204629 A1
(43) Pub. Date: Jun. 20, 2024

(54) POWER TOOL AND MOWER

(71) Applicant: Nanjing Chervon Industry Co., Ltd., Nanjing (CN)

(72) Inventors: Yanqing Xu, Nanjing (CN); Yufei Ren, Nanjing (CN)

(21) Appl. No.: 18/595,639

(22) Filed: Mar. 5, 2024

Related U.S. Application Data
(63) Continuation of application No. PCT/CN2022/116563, filed on Sep. 1, 2022.

(30) Foreign Application Priority Data
Oct. 29, 2021 (CN) 202111269374.X
Dec. 24, 2021 (CN) 202111597079.7
Jun. 21, 2022 (CN) 202210706056.3

(51) Int. Cl. H02K 11/35; A01D 34/00; A01D 34/68; A01D 34/69; A01D 34/78; H02K 7/14

(52) U.S. Cl. CPC H02K 11/35; A01D 34/006; A01D 34/6806; A01D 34/69; A01D 34/78; H02K 7/145

(57) ABSTRACT

A power tool includes transmission lines capable of transmitting power or communication data; and multiple function modules electrically connected to the transmission lines and capable of selectively receiving the communication data from the transmission lines or transmitting the communication data to the transmission lines. A transmission frequency at which the transmission lines transmit the communication data is greater than or equal to 1 kHz.

### RELATED APPLICATION INFORMATION

This application is a continuation of International Application Number PCT/CN2022/116563, filed on Sep. 1, 2022, through which this application also claims the benefit under 35 U.S.C. § 119(a) of Chinese Patent Application No. 202111269374.X, filed on Oct. 29, 2021, Chinese Patent Application No. 202111597079.7, filed on Dec. 24, 2021, and Chinese Patent Application No. 202210706056.3, filed on Jun. 21, 2022, which applications are incorporated herein by reference in their entireties.

### TECHNICAL FIELD

The present application relates to the technical field of power tools, for example, a large power tool with relatively many internal modules.

### BACKGROUND

As a large power tool, a garden tool that can implement more functions has more function modules involved inside, and thus relatively many power lines and transmission lines are arranged in the tool. So many harnesses may lead to complex production processes and low reliability. The reliability of communication between modules directly affects the reliability and user experience of the product.

### SUMMARY

A power tool includes transmission lines capable of transmitting power or communication data; and multiple function modules electrically connected to the transmission lines and capable of selectively receiving the communication data from the transmission lines or transmitting the communication data to the transmission lines. A transmission frequency at which the transmission lines transmit the communication data is greater than or equal to 1 kilohertz (kHz).

A garden tool includes a main body including a working assembly and a control unit; an operation device connected to the main body and having an operation module capable of generating an operation instruction; a power module configured to provide a power source for the garden tool; a drive motor configured to provide a driving force for the garden tool; and transmission lines capable of transmitting power or communication data. The control unit, the operation module, the power module, or the drive motor is electrically connected to the transmission lines and capable of selectively receiving the communication data from the transmission lines or transmitting the communication data to the transmission lines.

A mower includes a main body including a control unit, a cutting assembly, and a walking assembly, the cutting assembly being configured to cut vegetation, and the walking assembly being configured to drive the mower to walk; a first drive motor configured to drive the cutting assembly to perform mowing; a second drive motor configured to drive the walking assembly to walk; a handle device connectable to the main body and having an operation module capable of generating an operation instruction; a power module configured to provide a power source for the mower; and transmission lines capable of transmitting power or communication data.

The control unit, the first drive motor, the second drive motor, the operation module, or the power module is electrically connected to the transmission lines and capable of selectively receiving the communication data from the transmission lines or transmitting the communication data to the transmission lines.

A data communication method applicable to a power tool is provided. The power tool includes transmission lines capable of transmitting power or communication data; and multiple function modules electrically connected to the transmission lines and capable of selectively receiving the communication data from the transmission lines or transmitting the communication data to the transmission lines. Each of the multiple function modules includes a microcontroller having a data port for sending or receiving the communication data. The data communication method among multiple microcontrollers includes sending a handshake signal to a node in a data communication system at a set time interval to request networking with the node in the data communication system; receiving response information fed back by a node that supports networking and networking with the node that supports networking; determining a bus state according to the response information; and sending a token to a target node according to the bus state so that the target node transmits data by using the token.

A data communication method applicable to a power tool is provided. The power tool includes transmission lines capable of transmitting power or communication data; and multiple function modules electrically connected to the transmission lines and capable of selectively receiving the communication data from the transmission lines or transmitting the communication data to the transmission lines. Each of the multiple function modules includes a microcontroller having a data port for sending or receiving the communication data. The data communication method among multiple microcontrollers includes detecting differential signal levels on differential signal lines within a set time period; determining a bus state according to the differential signal levels; and transmitting to-be-transmitted data of a current node according to the bus state.

A data communication method applicable to a power tool is provided. The power tool includes transmission lines capable of transmitting power or communication data; and multiple function modules electrically connected to the transmission lines and capable of selectively receiving the communication data from the transmission lines or transmitting the communication data to the transmission lines. Each of the multiple function modules includes a microcontroller having a data port for sending or receiving the communication data. The data communication method among multiple microcontrollers includes setting a busy and idle indication signal indicating a busy or idle state of the transmission lines in a communication system;

and determining the busy or idle state of the communication system, determining, according to determination times of different nodes, a target node for currently sending data, and controlling the target node to send the communication data.

A power tool includes a tool housing; a motor configured to generate a driving force; a driver circuit including multiple switch elements; a tool controller electrically connected to at least the driver circuit and configured to output control signals for controlling the switch elements in the driver circuit to change conduction states to control a working state of the motor; tool power terminals connectable to a power device to supply power to the motor; a first modulation unit connected to the tool controller and capable of performing signal modulation on first communication data and coupling a first modulation signal obtained after modulation to the tool power terminals for output; and a first demodulation unit configured to access a second modulation signal input from the tool power terminals, demodulate second communication data transmitted by the power device, and send the second communication data to the tool controller.

A battery pack includes a cell group configured to store electrical energy; battery power terminals configured to transmit power to a power tool; a battery controller configured to control a discharge state of the battery pack; a second modulation unit connected to the battery controller and capable of performing signal modulation on second communication data and coupling a second modulation signal obtained after modulation to the battery power terminals for output; and a second demodulation unit configured to access a first modulation signal input from the battery power terminals, demodulate first communication data transmitted by the power tool, and send the first communication data to the battery controller.

A tool system includes the preceding power tool.

A tool system includes the preceding battery pack.

### BRIEF DESCRIPTION OF THE DRAWINGS

FIG. 1 is a circuit schematic of a power tool according to an example.

FIG. 2 is a structural diagram of a power tool according to an example.

FIG. 3 is a schematic diagram of signal fluctuations in a transmission line according to an example.

FIG. 4 is a structural view of a mower according to an example.

FIG. 5 is a circuit diagram of the mower shown in FIG. 4.

FIG. 6 is a structural view of a snow thrower according to an example.

FIG. 7 is a circuit diagram of the snow thrower shown in FIG. 6.

FIG. 8 is a flowchart of a data communication method according to an example of the present application.

FIG. 9 is a schematic of a networking mechanism of four nodes in a loop token method of a data communication method according to an example of the present application.

FIG. 10 is a schematic of an arbitration mechanism of three nodes in a loop token method of a data communication method according to an example of the present application.

FIG. 11 is a schematic of a networking mechanism of four nodes in a distributed token method of a data communication method according to an example of the present application.

FIG. 12 is a schematic of an arbitration mechanism of four nodes in a distributed token method of a data communication method according to an example of the present application.

FIG. 13 is a flowchart of another data communication method according to an example of the present application.

FIG. 14 is a communication detection circuit diagram of another data communication method according to an example of the present application.

FIG. 15 is a structural diagram of a data communication system according to an example of the present application.

FIG. 16 is a flowchart of a data communication method according to an example of the present application.

FIG. 17 is a structural view of a tool system according to an example.

FIG. 18 is a circuit schematic of a tool system according to an example.

FIG. 19 is a circuit schematic of a power tool according to an example.

FIG. 20 is a circuit schematic of a power tool according to an example.

FIG. 21 is a circuit schematic of a battery pack according to an example.

### DETAILED DESCRIPTION

The present application is described below in conjunction with drawings and examples. It is to be understood that the examples described herein are intended only to illustrate the present application. Additionally, it is to be noted that for ease of description, only part, not all, of structures related to the present application are illustrated in the drawings.

It is to be noted that a power tool of the present application may include a garden tool such as a mower, a snow thrower, a string trimmer, and a blower or large power tools of other types each including relatively many internal function modules.

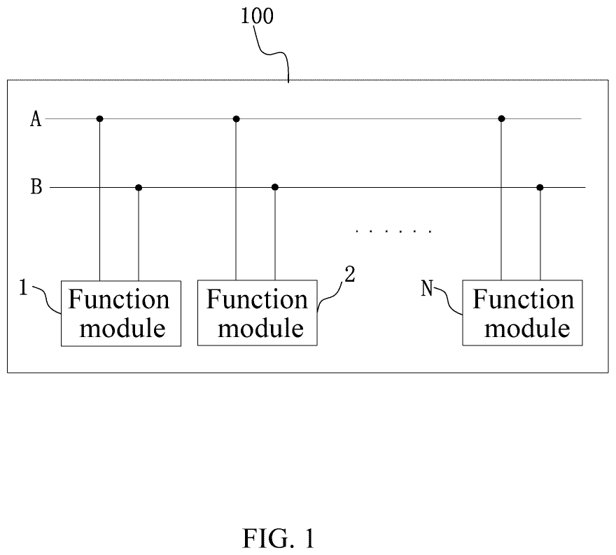

As shown in FIG. 1, a power tool 100 includes at least a pair of transmission lines A and B inside. The transmission lines A and B can transmit at least one of power and communication data. That is to say, function modules inside the power tool in this example can transmit power and communication data simply through the pair of transmission lines, and responsible transmission lines no longer need to be provided. In an example, the transmission lines are a pair of power lines. In this example, multiple function modules 1, 2, . . . , and N are electrically connected to the transmission lines A and B, and each function module has a different function. For example, a power module can provide power or output a power supply parameter related to a power device, a power management module can manage charging and discharging processes of a battery pack or other types of power sources, and a parameter detection module can detect a parameter related to the tool or working parameters of some components in the tool. The modules that may be involved in the tool are not listed one by one here.

In an example, a transmission frequency at which the transmission lines transmit the communication data is greater than or equal to 1 kHz. In an example, the frequency at which the transmission lines A and B transmit the communication data may be greater than or equal to 10 kHz.

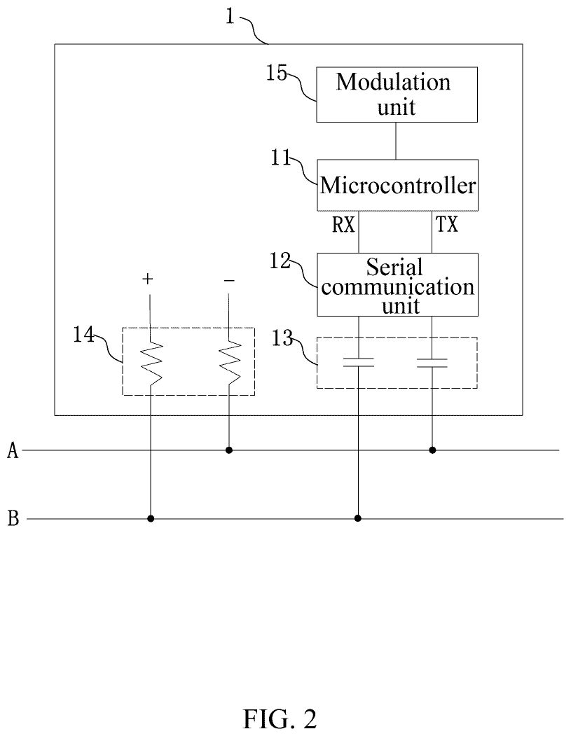

In an example, as shown in FIG. 2, the function module may include a microcontroller 11, and the microcontroller 11 has at least data input and output ports RX and TX. It is to be understood that the microcontroller 11 may also process received data to generate a control signal in response to the data. Optionally, the microcontroller 11 may be a microcontroller unit (MCU) chip. The function module may further include a serial communication unit 12, and the serial communication unit 12 may be connected to a data port of the microcontroller 11 to transmit, in a serial communication manner, data output from the microcontroller 11 to the transmission lines A and B. Optionally, the serial communication unit 12 may be a serial chip.

In this example, a power signal transmitted on the transmission lines A and B is a current signal, and the communication data output from the function module is generally a digital signal or an analog signal, such as a pulse-width modulation (PWM) signal. To transmit the communication data through power transmission lines, the function module may be further provided with a coupling element 13. Optionally, the coupling element 13 may be disposed between the function module and the transmission lines A and B. The coupling element 13 can couple the communication data onto the transmission lines A and B so that the communication data can be transmitted to another function module through the transmission lines. In an example, the communication data output from the function module may carry a communication identifier such as a communication address so that another function module can select, according to the communication address, whether the communication data needs to be accepted. In an example, as shown in FIG. 2, the coupling element 13 may be a capacitor element.

Since the communication data is transmitted on the transmission lines A and B, the function module cannot obtain pure power. Therefore, as shown in FIG. 2, a decoupling element 14 may be disposed in the function module. Optionally, the decoupling element 14 may be disposed between the function module and the transmission lines A and B. The decoupling element 14 can decouple the communication data on the transmission lines A and B so that the function module obtains pure power. In an example, the decoupling element 14 may be an inductor element.

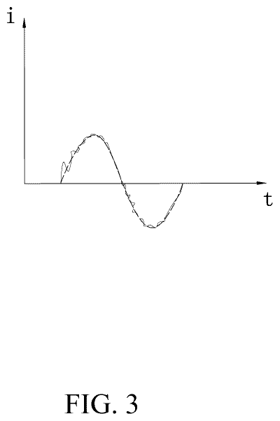

In an example, as shown in FIG. 3 (where the abscissa t represents time, and the ordinate i represents a signal in the transmission lines), a dashed line represents a signal transmission process in the absence of current fluctuations, and a solid line represents a signal transmission process in the presence of current fluctuations. When the transmission lines transmit power, due to an effect of an external environment, unstable power output performance, or the like, the current signal may suddenly change, causing signal interference to a signal coupled with the communication data. To solve the problem, the microcontroller 11 in the function module may calculate a difference between signals transmitted on two power lines to obtain a differential signal. Since the signals transmitted on two current lines are subjected to current fluctuations with basically the same amplitudes or frequencies, it may be considered that after the signals are transmitted on the current lines, the differential signal of the communication data is not affected by the current fluctuations, thereby avoiding interference to the communication data and ensuring accuracy of data communication between modules in the tool.

In an example, the function module further includes a modulation unit 15, and the modulation unit 15 can modulate the communication data to be sent to the transmission lines, so as to prevent a single high-level or low-level signal from failing to be identified. Accordingly, the communication data received by the function module needs to be demodulated by the modulation unit 15. That is to say, the modulation unit 15 may modulate a signal or demodulate a signal. Optionally, a modulation unit and a demodulation unit may be separately disposed in the function module.

In the preceding examples, the present application is described by using the power tool with the multiple function modules as an example. For example, the solutions of the present application may be applied to a mower.

In another example of the present application, a carrier communication manner between different function modules in the mower is described by using a mower 200 as an example.

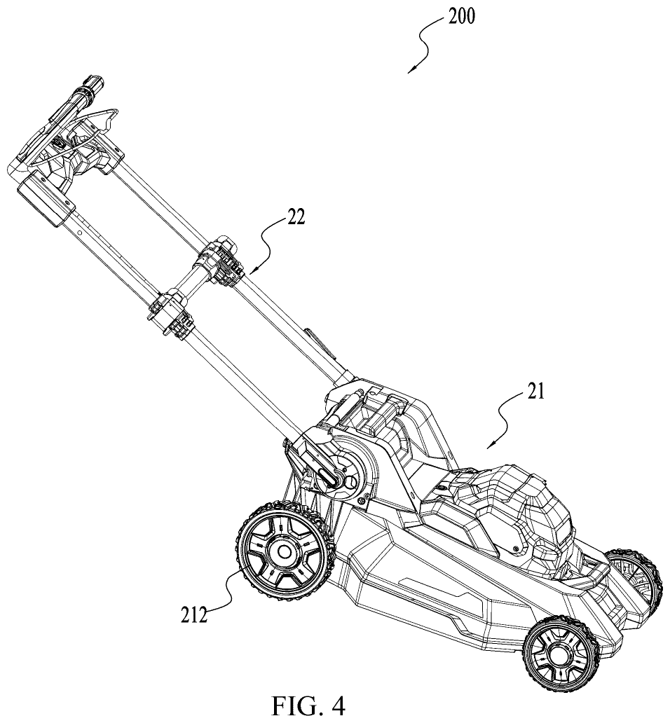

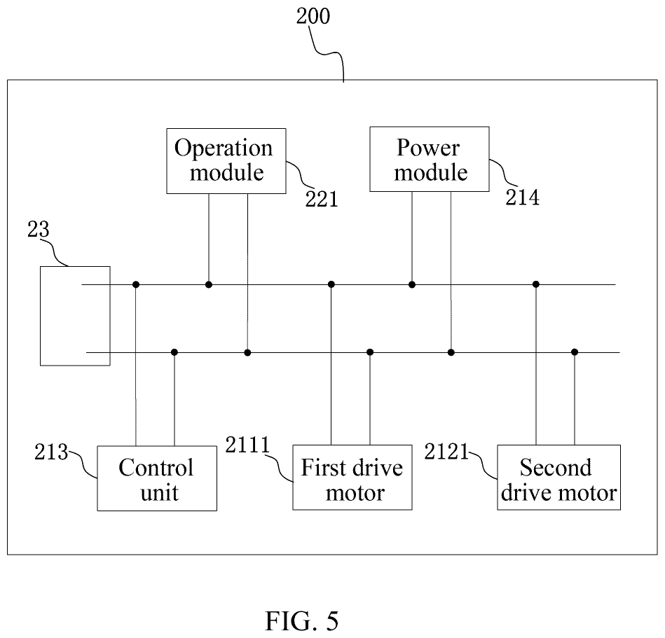

As shown in FIGS. 4 and 5, the mower 200 mainly includes a main body 21 and a handle device 22 used as an operation device. In this example, a working assembly disposed on the main body 21 mainly includes a cutting assembly and a walking assembly 212. The cutting assembly can cut vegetation, and the walking assembly 212 can drive the mower 200 to walk. The main body 21 further includes a control unit 213 capable of controlling a first drive motor 2111 for driving the cutting assembly and a second drive motor 2121 for driving the walking assembly 212. The handle device 22 includes at least an operation module 221 that can respond to an operation performed by a user on a handle and generate an operation instruction. Optionally, the operation module 221 may be disposed on the main body 21. In an example, the operation module 221 may include a switch unit, a speed regulation unit, a display unit, and the like. Additionally, the main body 21 may further include a power module 214 capable of providing power for the mower 200. In an example, the power module 214 may be a 1P or 2P battery pack. The mower 200 further includes transmission lines 23. Function units or modules on the main body 21 and the handle device 22 may be electrically connected to the transmission lines 23. For example, the control unit 213, the first drive motor 2111, the second drive motor 2121, the operation module 221, or the power module 214 is electrically connected to the transmission lines 23. Optionally, different function units in the operation module 221 may be separately connected to the transmission lines 23 or may be connected to the transmission lines 23 through the operation module 221. It is to be understood that the preceding function modules or units can selectively receive communication data from the transmission lines 23 or transmit communication data to the transmission lines 23. In this example, for a connection relationship and a data transmission relationship between the transmission lines 23 and the function modules, reference may be made to the description in the preceding examples. The details are not repeated here.

In this example, the main body 21 has a relatively long distance from the handle device 22, and the communication data is coupled onto power transmission lines so that communication between the function modules in the operation module 221 in the handle device 22 and the main body 21 is implemented, thereby reducing harnesses arranged in the tool and ensuring stable performance of the tool.

In another example of the present application, the solutions of the present application are described by using a snow thrower 300 as an example.

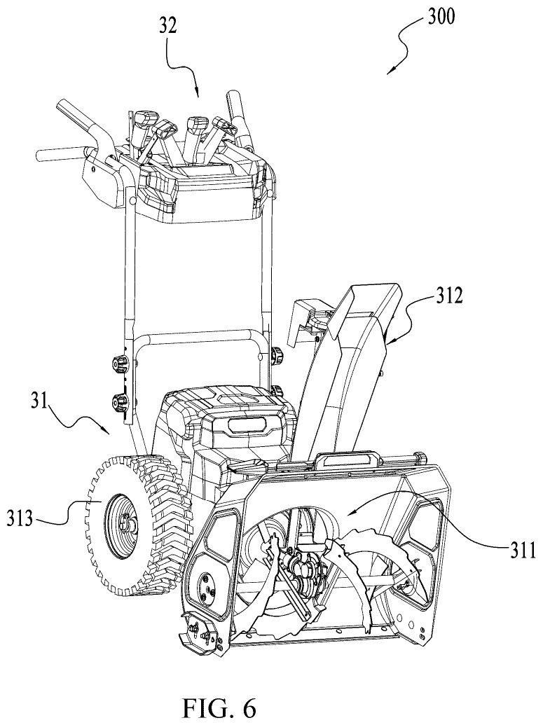

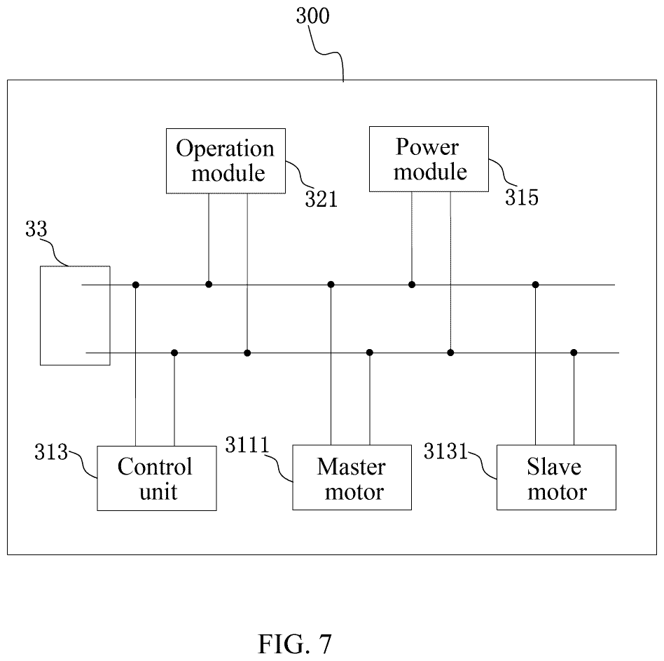

As shown in FIGS. 6 and 7, the snow thrower 300 includes a main body 31 and a handle device 32 used as an operation device. In this example, a working assembly disposed on the main body 31 mainly includes a snow sweeping device 311, a snow throwing device 312, a walking device 313, and a control unit 314. Optionally, the main body 31 further includes a power module 315. The power module 315 may be a single battery pack or a double battery pack, where the battery pack includes a lithium battery in a battery pack housing.

In this example, the snow sweeping device 311 mainly includes a snow sweeping paddle and a rotary paddle. The snow sweeping device 311 may be driven by a master motor 3111. The walking device 313 may include walking wheels and can be driven by a slave motor 3131 to drive the snow thrower 300 to walk. The handle device 32 includes various trigger mechanisms that can be triggered by a user. Optionally, the handle device 32 includes an operation module 321 that can generate an operation instruction according to an operation performed by the user on a trigger mechanism. The snow thrower 300 further includes transmission lines 33. Function units or modules on the main body 31 and the handle device 32 may be electrically connected to the transmission lines 33. For example, the control unit 314, the master motor 3111, the slave motor 3131, the operation module 321, or the power module 315 is electrically connected to the transmission lines 33. It is to be understood that different trigger mechanisms on the handle device 32 may correspond to different trigger units separately, and each trigger unit may be a small function module.

In an optional implementation manner, different function units in the operation module 321 may be separately connected to the transmission lines 33 or may be connected to the transmission lines 33 through the operation module 321. It is to be understood that the preceding function modules or units can selectively receive communication data from the transmission lines 33 or transmit communication data to the transmission lines 33. In this example, for a connection relationship and a data transmission relationship between the transmission lines 33 and the function modules, reference may be made to the description in the preceding examples. The details are not repeated here.

In this example, the main body 31 has a relatively long distance from the handle device 32, and the communication data is coupled onto power transmission lines so that communication between the function modules in the operation module 321 in the handle device 32 and the main body 31 is implemented, thereby reducing harnesses arranged in the tool and ensuring stable performance of the tool.

In the examples of the present application, a data communication system composed of different function modules of the power tool may be applied to various garden tools such as a string trimmer and a blower in addition to the mower and the snow thrower and may also be applied to various handheld power tools or large or small power tools of other types each including relatively many internal function modules.

A control circuit of some power tools is generally a traditional circuit that generally uses five lines for connections, including two differential signal lines (for signal transmission), two power positive and negative lines (for power supply), and one busy and idle line (for detecting whether data is currently transmitted on a bus). A data transmission manner corresponding to the traditional circuit is independent transmission. In the examples of the present application, a hardware circuit is simplified, the busy and idle line is cancelled, and the two power lines and the two signal lines in the traditional circuit are multiplexed, that is, two transmission lines after simplification are used for both power supply and differential signal and data transmission, and a data transmission manner in the examples of the present application is dependent transmission.

At most one printed circuit board (PCB) in the system can transmit a signal out. Otherwise, signal interference occurs, resulting in a data transmission error. Therefore, examples of the present application provide a data communication method to determine which PCB sends data out.

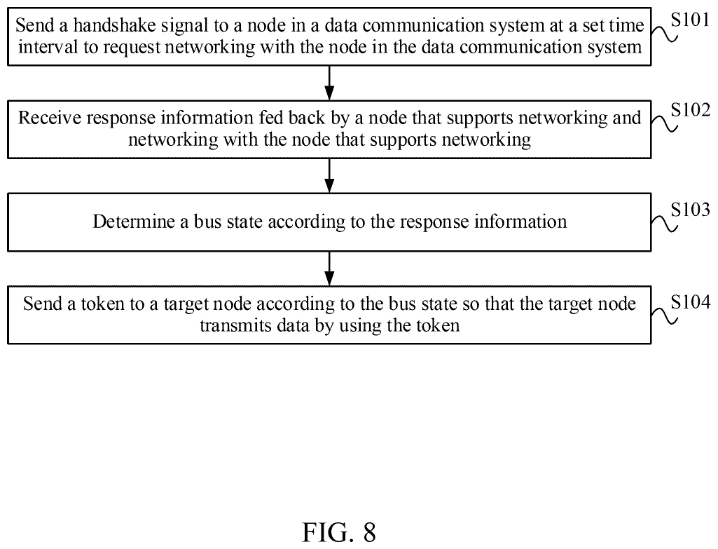

FIG. 8 is a flowchart of a data communication method for a data communication system in a power tool. The method may include the steps below.

In S101, a handshake signal is sent to a node in the data communication system at a set time interval so as to request networking with the node in the data communication system.

The set time interval may be a time interval for sending the handshake signal and preset according to an actual situation, for example, may be 1 millisecond (ms) or 2 ms.

In the example, the data communication system may be a system for communication between different function modules in the power tool. Each function module may include, for example, a microcontroller, a serial communication unit, a coupling element, a decoupling element, a modulation unit, and the like. Accordingly, the node may be a different function module in the power tool or an MCU in the module. Optionally, the node in this example may be a PCB.

It is to be explained that the handshake signal may be understood as a signal sent by a sending node to a receiving node and used for requesting to establish a connection relationship before data communication in a data communication process.

It is to be noted that the networking may be understood as a communication network composed of at least one node in the data communication system and used for data communication between nodes.

Optionally, different hardware may be distinguished through different combination manners of high and low levels of hardware input/output (IO) ports so that nodes (PCBs) are physically numbered, and their respective physical addresses are determined. A node 1 (which may be considered as an indispensable node in the whole data communication system and is configured to monitor a token transmission situation in the whole data communication system) may be used as a starting node. The node 1 sends the handshake signal to another node in the data communication system at the set time interval to request the networking with another node in the data communication system.

In S102, response information fed back by a node that supports networking is received and the networking is performed with the node that supports networking.

It is to be noted that the node that supports networking refers to a node that exists in the data communication system and can network with the node 1 to perform data communication.

The response information may be information that is fed back by the node that supports networking to the node 1 and can support the networking.

Optionally, after the node 1 sends the handshake signal to the node in the data communication system at the set time interval, the node that supports networking feeds back the response information to the node 1, and the node 1 receives the response information fed back by the node that supports networking and determines an existing node in the data communication system according to the response information to complete the networking with the node that supports networking.

In an actual process, the handshake signal starts to be sent out from a PCB with a node number 1. In the presence of a node 2 in the network, the node 2 feeds back the response information to the node 1, and the node 1 establishes communication with the node 2, indicating that the node 2 receives data from the node 1. In the absence of the node 2 in the network, the node 1 cannot receive, within a period of time, the response information fed back by the node 2, and the node 1 sends the handshake signal to a node 3 until the networking with a node with a maximum number is completed to form a complete data receive chain.

In S103, a bus state is determined according to the response information.

In this example, the PCBs communicate with each other through a bus. The bus state may be busy or idle. Busy means that data is currently transmitted on the bus, and idle means that no data is currently transmitted on the bus.

Optionally, the node 1 determines the bus state according to the response information fed back by the node that supports networking.

In S104, a token is sent to a target node according to the bus state so that the target node transmits data by using the token.

The target node refers to a next node to which the node 1 transmits data during data communication. One or more target nodes may exist. For example, if the node 1 transmits data to the node 3 and a node 5, the node 3 and the node 5 are both target nodes.

It is to be explained that the token is a data form and may be understood as a certificate for the node to perform data transmission, that is, only when the node has the token, can the node transmit data out. To ensure that transmit frequencies of all the PCBs (nodes) have no significant difference, it needs to be ensured that the token is transmitted regularly, that is, it is ensured that after a certain node sends the token out, the token can be received by all the nodes and can only be parsed and approved by a fixed node.

It is to be noted that transmitting data refers to that the node transmits communication data out. For a format of transmitted data, for example, a frame of data may include a frame header 1, a frame header 2, the target node, all the nodes, most significant eight cyclic redundancy check (CRC) bits, and least significant eight CRC bits. The frame header represents an identity (ID) of the transmitted data (which refers to an identifier of the transmitted data in the example); the target node is used for determining a transmission order of the token; all the nodes are used for determining whether a new node is a newly added node; and CRC is used for verifying whether the transmitted data is normal.

Optionally, the node 1 sends the token to the target node in the data communication system according to the bus state so that the target node transmits the data by using the token. In this example, in a transmission direction from the node 1 to the target node, the bus state may be considered as idle, and the data can be transmitted.

A carrier communication manner is used in the examples of the present application so that differential signal lines and power positive and negative lines are multiplexed, a busy and idle line is used in the form of the token on data lines, and five lines are reduced to two lines, thereby simplifying a hardware structure and making new adjustments to control logics of software. Whether the node can send the token or transmit data may be determined according to the bus state so that reliable data arbitration can be completed even if lines are multiplexed, thereby improving data communication reliability.

Optionally, the number of target nodes is 1; and the target node is a node that feeds back the response information.

For example, one target node feeds back the response information currently. In this example, the token or data may be transmitted in a loop manner. That is, after a current node sends the token, only a certain node parses and approves the token and feeds back the response information, and the current node uses the node that feeds back the response information as the target node and sends the token or data to the target node. On this basis, after having the token, the target node may continue to send the token to another node, so as to form the subsequent transmission path.

Optionally, the method further includes determining a token transmission path according to the response information.

It is to be noted that the token transmission path refers to a path along which the token is transmitted among the nodes. For example, the token transmission path may be from the node 1 to the node 2 and then from the node 2 to the node 3.

Optionally, the node 1 determines the token transmission path according to the response information fed back by the node that supports networking.

Optionally, the step in which the token is sent to the target node according to the bus state so that the target node transmits the data by using the token includes the step below.

The token is sent to the target node according to the bus state so that after transmitting the data, the target node sends the token to a next-hop node according to the token transmission path.

It is to be noted that the next-hop node refers to a next node to which the target node transmits the data during the data communication.

In an actual operation process, the next-hop node of the node 1 may be the node 2 or may not be the node 2. For example, the data communication system originally has eight nodes, which are separately numbered the node 1, the node 2, the node 3, a node 4, the node 5, a node 6, a node 7, and a node 8. A normal transmission path should be node 1-node 2-node 3-node 4-node 5-node 6-node 7-node 8-node 1. However, the node 2 and the node 7 may not exist in reality, and the transmission path should be node 1-node 3-node 4-node 5-node 6-node 8-node 1. Therefore, the next target node of the node 1 is not necessarily the node 2 and may be the node 3 or the node 4. Therefore, after each power-on, the data communication system needs to perform the networking to determine the target node and the next-hop node. In the actual process, the node 1 sends the token to all the remaining nodes, all the nodes parse token data and parse out the token sent by the node 1, and then which node receives the token is determined, that is, the target node is determined. For example, in a manner where the transmission path is node 1-node 3-node 4-node 5-node 6-node 8-node 1, the node 1 sends the token, the node 3 uses the token, and after receiving the token, the node 3 determines whether data needs to be sent to the bus.

Optionally, the node 1 sends the token to the target node according to the bus state. After receiving the token, the target node determines whether the data needs to be sent. If the data needs to be sent, the target node sends the data and then sends the token to the next-hop node according to the token transmission path after transmitting the data.

Alternatively, the token is sent to the target node according to the bus state so that in the case where no data is transmitted, the target node sends the token to the next-hop node according to the token transmission path.

Optionally, the node 1 sends the token to the target node according to the bus state. After receiving the token, the target node determines whether the data needs to be sent. If the data does not need to be sent, the target node directly sends the token to the next-hop node according to the token transmission path.

Optionally, the method further includes that if a time for which the token remains at any node in the networking exceeds a fixed time, the node is forced to send the token to the next-hop node.

It is to be explained that the time for which the token remains refers to a time for which the token is not sent to the next-hop node and remains at any node in the networking after the node receives the token.

The fixed time may be a time set according to an actual situation and for which the token remains at any node in the networking under normal circumstances, for example, may be 1 ms or 2 ms.

Optionally, if the time for which the token remains at any node in the networking exceeds the set fixed time, the node is forced to send the token to the next-hop node, thereby avoiding a communication abnormality due to the remaining of the token.

Optionally, the method further includes that if the token is not received within a set time, the token is resent to the target node according to the bus state.

The set time may be a time set according to an actual situation and from when the token is sent by the previous node to when the token is received by any next node in the networking under normal circumstances, for example, may be 1 ms or 2 ms. The set time is greater than or equal to a product of the number of nodes in the networking and a time for determining a token sending abnormality.

It is to be known that the number of nodes refers to a quantity of nodes in the networking.

It is to be explained that the time for determining the token sending abnormality refers to a time for determining whether the token remains at a certain node in a data transmission process.

Optionally, if the token is not received by the node within the set time, the token is resent to the target node according to the bus state. It is to be noted that the set time is greater than or equal to the product of the number of nodes in the networking and the time for determining the token sending abnormality. The most extreme situation is considered here since the token may not be lost but a data jam exists at each node. Even if the token is not lost and is possible to be received again, if the token is not received within the set time, the token is considered lost.

Optionally, the method further includes that if the token is detected to be lost at any node in the networking, the token is resent to the target node.

It is to be understood that the token is also data transmitted on power lines and an occasional data loss in a communication process is normal, so the token is occasionally lost. After the token is lost, any node cannot send data out due to the absence of the token. Therefore, if the token is detected to be lost at any node in the networking, the token is resent to the target node.

After the token is resent for a set number of times, if the token is still lost, the handshake signal is resent to the node in the data communication system at the set time interval so as to request re-networking with the node in the data communication system.

Optionally, the set number of times may be a number of times that are set according to an actual situation and for which the token is resent to the target node after the token is detected to be lost at any node in the networking, for example, may be three times or five times.

It is to be understood that when a certain node is lost from the network due to a problem of the node itself, the token cannot be transmitted in the network that has successful networking, which is embodied as the token being lost. After the token is resent, the node still cannot receive the token, and the process is repeated. After it is continuously determined multiple times that the token is lost, the node may be considered lost, and the handshake signal is resent to the node in the data communication system at the set time interval so as to request the re-networking with the node in the data communication system.

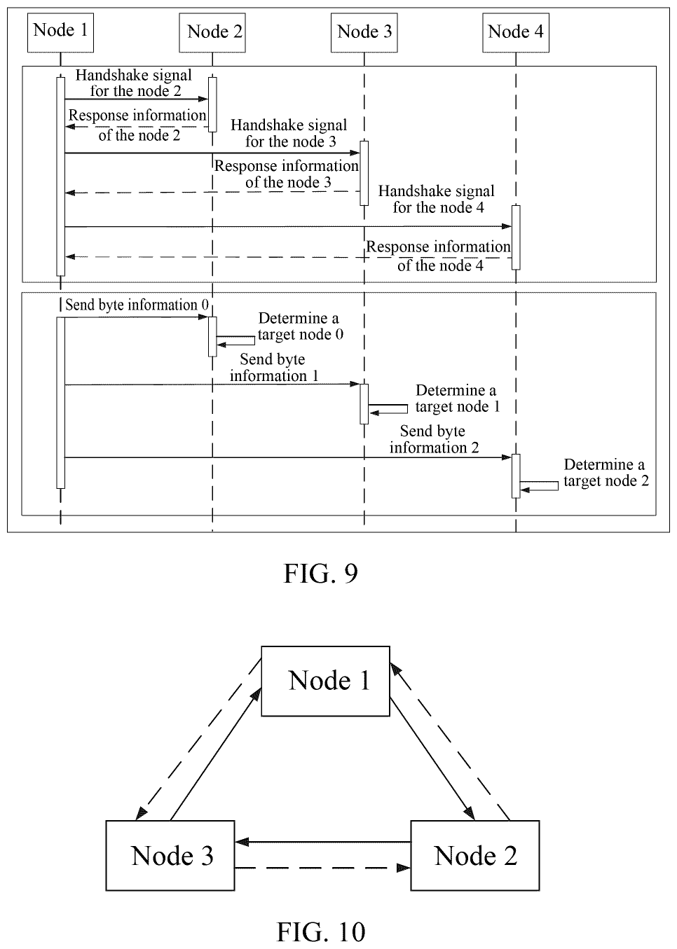

As an exemplary description of this example, FIG. 9 is a schematic of a networking mechanism of four nodes in a loop token method of a data communication method according to example one of the present application, where the networking mechanism is applicable to the case where the data communication is performed by the loop token method. The loop token method may be understood as a method in which the nodes form a loop, and the token is transmitted along the loop among the nodes. The loop token method may be applied to the case where only one target node exists. The networking mechanism in the loop token method is described below by using four nodes as an example. As shown in FIG. 9, a process of networking among the four nodes may include the operations below.

Hardware numbering is performed on the PCBs (nodes), and their respective physical addresses are determined.

The node 1 sends the handshake signal to the node 2, the node 3, and the node 4 in the data communication system at the set time interval. For example, the node 1 sends a handshake signal for the node 2 to the node 2, the node 1 sends a handshake signal for the node 3 to the node 3, and the node 1 sends a handshake signal for the node 4 to the node 4.

The node that supports networking feeds back the response information to the node 1. For example, the node 2 feeds back response information of the node 2 to the node 1, the node 3 feeds back response information of the node 3 to the node 1, and the node 4 feeds back response information of the node 4 to the node 1.

After the node 1 networks with the node 2, the node 3, and the node 4, the node 1 determines existing nodes in the network according to the response information to form byte information.

The node 1 sends the byte information to each node, and each node determines the target node according to its physical address and the byte information. For example, the node 1 sends byte information 0 to the node 2, and the node 2 determines a target node 0 according to its physical address and the byte information 0; the node 1 sends byte information 1 to the node 3, and the node 3 determines a target node 1 according to its physical address and the byte information 1; and the node 1 sends byte information 2 to the node 4, and the node 4 determines a target node 2 according to its physical address and the byte information 2.

After the networking is completed, the node 1 determines the bus state according to the response information and sends the token to the target node according to the bus state so that the target node transmits the data by using the token.

As an exemplary description of this example, FIG. 10 is a schematic of an arbitration mechanism of three nodes in a loop token method of a data communication method according to example one of the present application, where the arbitration mechanism is applicable to the case where the data communication is performed by the loop token method. The arbitration mechanism in the loop token method is described below by using three nodes as an example. As shown in FIG. 10, a process of token sending arbitration among the three nodes may include the operations below.

The node 1 sends the token to all the nodes, but only the node 2 obtains the token, and the node 2 may feed back the response information to the node 1; the node 3 receives the token from the node 2, and the node 3 may feed back the response information to the node 2; and the node 1 receives the token from the node 3, and the node 1 may feed back the response information to the node 3, so as to form a transmission manner of node 1→node 2→node 3→node 1. After obtaining the token, the node 2 and the node 3 determine whether data needs to be sent. If the data needs to be sent, the data is sent, and then the token is sent to the next-hop node. If no data needs to be sent, the token is directly sent to the next-hop node.

The loop token method can detect, in real time, whether the token is lost and whether the node is lost, but the data communication system cannot determine whether a node is added.

Optionally, the response information includes a priority and a transmit frequency corresponding to each node that supports networking.

It is to be noted that the priority refers to a priority at which the node sends the token. For example, when multiple nodes need to simultaneously send the token, a node with a high priority may send the token first, and a node with a low priority may send the token later. For another example, the node 1 may determine, according to the priority corresponding to each node, which node the token is sent to first. Each node that supports networking may correspond to a different priority. For example, a priority of the node 2 is higher than that of the node 3. That is, when the node 1 needs to send the token to both the node 2 and the node 3, since the priority of the node 2 is higher than that of the node 3, the node 1 first sends the token to the node 2.

It is to be explained that the transmit frequency refers to a frequency at which data is sent between any two nodes. For example, the node 1 may send data to the node 2 every 2 ms.

For example, the node 1 sends the handshake signal to the node in the data communication system at the set time interval to request the networking with the node in the data communication system, and each node that supports networking feeds back to the node 1 the priority and the transmit frequency corresponding to the node that supports networking.

Optionally, the target node includes each node that supports networking.

In this example, the token or data may be transmitted in a distributed manner, and multiple target nodes may exist. That is, the current node may send (according to the priority) the token to the nodes in the networking separately, and the nodes may complete data transmission by using the token or discard the token in the case where no data needs to be transmitted.

The step in which the token is sent to the target node according to the bus state includes sending the token to each node that supports networking according to the priority corresponding to each node that supports networking.

For example, the node 1 may send the token to each node that supports networking according to the priority corresponding to each node that supports networking. When the node 1 needs to send the token and is a node with a highest priority currently, the node 1 may send the token to other nodes. In this case, the bus state corresponding to the node 1 may be considered idle.

Optionally, the step in which the token is sent to each node that supports networking according to the priority corresponding to each node that supports networking includes the steps below.

After the token is sent to each node that supports networking, a feedback signal is received from the node.

It is to be noted that the feedback signal refers to a signal that each node that supports networking feeds back to the node 1 after receiving the token sent by the node 1 and sending data out.

For example, after the node 1 sends the token to each node that supports networking, each node that supports networking sends data out and sends the feedback signal to the node 1 after sending the data, and the node 1 receives the feedback signal from the node.

After the feedback signal is received from the node, the token is sent to a next node that supports networking according to the priority corresponding to each node that supports networking.

For example, after receiving the feedback signal from the node, the node 1 sends the token to the next node that supports networking according to the priority corresponding to each node that supports networking.

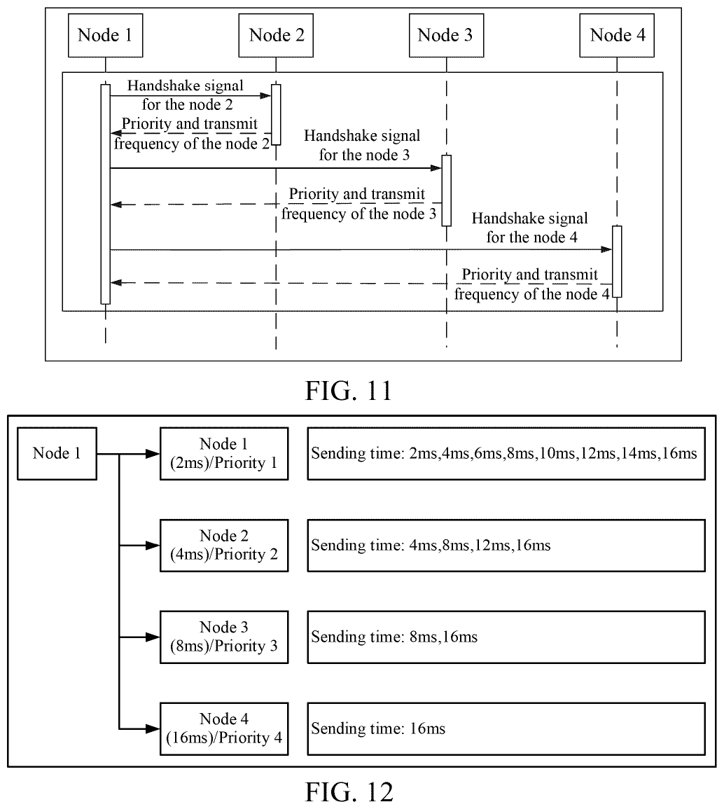

As an exemplary description of this example, FIG. 11 is a schematic of a networking mechanism of four nodes in a distributed token method of a data communication method according to example one of the present application, where the networking mechanism is applicable to the case where the data communication is performed by the distributed token method. The distributed token method may be understood as a method in which the node 1 sends the token to each node that supports networking according to the transmit frequency corresponding to each node that supports networking. The distributed token method may be applied to the case where each node that supports networking is the target node. The networking mechanism in the distributed token method is described below by using four nodes as an example. As shown in FIG. 11, the process of networking among the four nodes may include the operations below.

The hardware numbering is performed on the PCBs (nodes), and their respective physical addresses are determined.

The node 1 sends the handshake signal to the node 2, the node 3, and the node 4 in the data communication system at the set time interval. For example, the node 1 sends the handshake signal for the node 2 to the node 2, the node 1 sends the handshake signal for the node 3 to the node 3, and the node 1 sends the handshake signal for the node 4 to the node 4.

The node that supports networking feeds back the priority and the transmit frequency to the node 1. For example, the node 2 feeds back a priority and transmit frequency of the node 2 to the node 1, the node 3 feeds back a priority and transmit frequency of the node 3 to the node 1, and the node 4 feeds back a priority and transmit frequency of the node 4 to the node 1.

After the node 1 sends the handshake signal to the last node (that is, the node with the maximum number) and the last node feeds back a priority and transmit frequency of the node to the node 1, the networking is completed.

The node 1 determines a sending period of the token according to priorities and transmit frequencies fed back by all the nodes.

As an exemplary description of this example, FIG. 12 is a schematic of an arbitration mechanism of four nodes in a distributed token method of a data communication method according to example one of the present application. The arbitration mechanism in the distributed token method is described below by using four nodes as an example. As shown in FIG. 12, the process of token sending arbitration among the four nodes may include the operations below.

For example, the node 1 sends data once every 2 ms and has a priority of 1; the node 2 sends data once every 4 ms and has a priority of 2; the node 3 sends data once every 8 ms and has a priority of 3; and the node 4 sends data once every 16 ms and has a priority of 4.

A least common multiple of the transmit frequencies of all the nodes is determined to be a cycle period. In one cycle period, the node 1 sends the token to each node according to the transmit frequency. After receiving the token, the node sends the data out and sends the feedback signal to the node 1. After receiving the feedback signal from the node, the node 1 sends the token to the next node that supports networking according to the priority corresponding to each node that supports networking.

In the distributed token method, for the format of the transmitted data, for example, the frame of data may include the frame header 1, the frame header 2, the sending node, the target nodes, the most significant eight CRC bits, and the least significant eight CRC bits. The frame header represents the ID of the transmitted data; the sending node represents an address of the node sending the token; the target nodes represent addresses of the nodes receiving the token; and CRC is used for verifying whether the transmitted data is normal.

The distributed token method can detect, in real time, whether the token is lost and whether the node is lost, and an additional resource is required for determining whether a node is added.

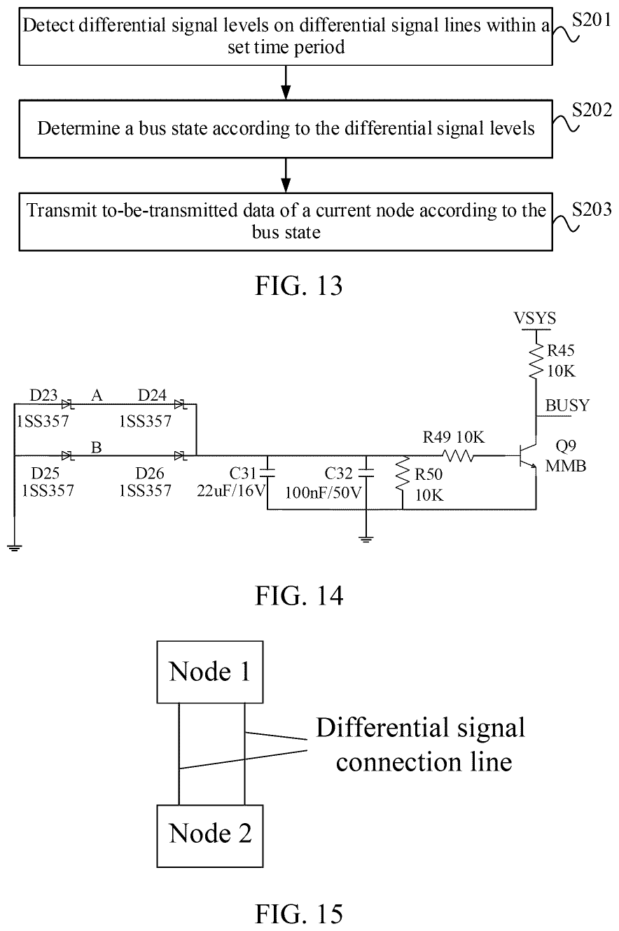

FIG. 13 is a flowchart of another data communication method according to an example of the present application. The method in FIG. 13 may include the steps below.

In S201, differential signal levels on differential signal lines within a set time period are detected.

The set time period may be a time period used for detecting the differential signal levels on the differential signal lines and preset according to an actual situation, for example, may be 1 ms or 2 ms.

In this example, the differential signal lines refer to two differential signal lines after two differential signal lines (for signal transmission) and two power positive and negative lines (for power supply) in a traditional circuit are simplified by being multiplexed. The two differential signal lines after simplification are used for both power supply and differential signal and data transmission.

It is to be noted that the differential signal levels refer to levels on the differential signal lines. The differential signal levels may be, for example, high or low.

For example, the differential signal levels on the two differential signal lines within the set time period are detected.

In S202, a bus state is determined according to the differential signal levels.

In an example, the bus state is determined according to the differential signal levels. For example, when the differential signal levels on the two differential signal lines are high-low or low-high, varying levels, it indicates that data exists on the differential signal lines, that is, the bus state is busy; when the differential signal levels on the two differential signal lines are fixed levels, that is, in a high-configuration receive mode, it indicates that no data exists on the differential signal lines, that is, the bus state is idle.

In S203, to-be-transmitted data of a current node is transmitted according to the bus state.

It is to be explained that the to-be-transmitted data refers to data of the current node to be transmitted out. In this example, for a format of transmitted data, for example, a frame of data may include a frame header 1, a frame header 2, a flag of a factory mode, address information, most significant eight data bits, least significant eight data bits, most significant eight CRC bits, and least significant eight CRC bits.

In an example, the to-be-transmitted data of the current node is transmitted according to the bus state. For example, when the bus state is idle, the to-be-transmitted data of the current node is transmitted out.

In the examples of the present application, the differential signal levels on the differential signal lines within the set time period are detected, the bus state is determined according to the differential signal levels, and the to-be-transmitted data of the current node is transmitted according to the bus state. According to the solution, no networking is required, no node in a network needs to be determined, no information about other nodes needs to be known, and each node is only required to push data to a bus so that data communication is finally implemented, and data communication reliability is improved.

Optionally, the step in which the bus state is determined according to the differential signal levels includes the steps below.

If the differential signal levels are the varying levels, the bus state is busy.

It is to be noted that the varying levels may be understood as that the differential signal levels on the two differential signal lines are high-low or low-high.

For example, if it is detected that the differential signal levels on the differential signal lines are the varying levels, it is determined that the bus state is busy.

If the differential signal levels are the fixed levels, the bus state is idle.

It is to be noted that the fixed levels may be understood as that the two differential signal lines are in the high-configuration receive mode.

For example, if it is detected that the differential signal levels on the differential signal lines are the fixed levels, it is determined that the bus state is idle.

Optionally, the step in which the to-be-transmitted data of the current node is transmitted according to the bus state includes the steps below.

If the bus state is idle, the to-be-transmitted data of the current node is transmitted on the bus.

For example, if it is determined that the bus state is idle, the current node sends data out and transmits the to-be-transmitted data of the current node on the bus.

If the bus state is busy, an operation of detecting the differential signal levels on the differential signal lines within the set time period is returned to.

For example, if it is determined that the bus state is busy, the operation of detecting the differential signal levels on the differential signal lines within the set time period is returned to.

Optionally, the step in which the to-be-transmitted data of the current node is transmitted according to the bus state includes the step below.

If the current node is in the factory mode, the to-be-transmitted data of the current node is transmitted according to the bus state after the factory mode is released.

It is to be explained that the factory mode is a particular working mode in which the node does not send or receive data according to an existing rule.

For example, if the current node is in the factory mode, data is not sent or received according to the existing rule, and after the factory mode is released, the to-be-transmitted data of the current node is transmitted according to the bus state.

As an exemplary description of this example, FIG. 14 is a communication detection circuit diagram of another data communication method according to example two of the present application. This example is applicable to data communication. As shown in FIG. 14, the communication detection circuit diagram includes electronic components such as diodes (for example, diodes D23, D24, D25, and D26 whose device model is 1SS357), capacitors (for example, a capacitor C31 whose model is 22 uf/16V and a capacitor C32 whose model is 100 nf/50V), resistors (for example, R45, R49, and R50 with a resistance of 10,000 ohms (10K)), and a transistor (for example, a transistor Q9 of an MMB series), where VSYS represents a power supply circuit.

Signal lines A and B are the two differential signal lines, and the circuit controls, through the two differential signal lines, Q9 to turn on or off to control the current node to transmit data or not.

Transmit (tx) data (TXD) is output from a serial port of a single-chip microcomputer and converted by a TP8485E (transceiver) chip into transformed AB signals (that is, differential signals), where different data correspond to different AB signals to form the varying levels.

A working mechanism of the data communication method is described below.

PCBs (nodes) are sequentially numbered for determining a data parsing relationship.

When data is transmitted on the differential signal lines, it is detected that A-B levels on the two differential signal lines are high-low or low-high, and the differential signal levels are the varying levels. When no data is transmitted on the differential signal lines, it is detected that the two differential signal lines, A-B lines, are in the high-configuration receive mode, and the differential signal levels are the fixed levels. For example, when data is transmitted on the differential signal lines, AB signal levels are 3 V (volt, a voltage unit)-Vv or Vv-3 V so that the switch Q9 turns on. In this case, BUSY is at a low level. When no data is transmitted on the differential signal lines, the AB signals are in a high-configuration receive state, and the switch Q9 cannot be turned on. In this case, BUSY is at a high level.

In the power-on, all nodes are in a receive state by default. When data needs to be sent, the differential signal levels on the differential signal lines within the set time period are detected. If it is detected that the differential signal levels on the differential signal lines within the set time period are always the fixed levels, the data is sent; if it is detected that the differential signal levels on the differential signal lines within the set time period are the varying levels, no data is sent and a transmit frequency is shortened.

A data communication abnormality is processed in different manners in different cases.

Node loss: Parsing nodes perform different processing.

Node addition: Hot swapping is supported.

Period conflict: A sending period and a waiting time are changed by small amplitudes.

Factory mode: Data can be sent only after the factory mode is released.

FIG. 15 is a structural diagram of another data communication system according to an example of the present application. The system in FIG. 15 includes multiple nodes (two nodes are shown as an example in FIG. 15), and the nodes are connected by two differential signal lines.

The multiple nodes transmit data by the data communication method according to the preceding examples. For example, data transmission may be performed by a loop token method or a distributed token method through the networking among the nodes, or no networking is performed among the nodes and data transmission may be directly performed through a detection circuit of the two differential signal lines.

In the data communication system of this example, differential signal lines and power positive and negative lines are multiplexed, a busy and idle line is used in the form of the token on data lines, and five lines are reduced to two lines, thereby simplifying a hardware structure and making new adjustments to control logics of software. Whether the node can send the token or transmit data may be determined according to the bus state so that reliable data arbitration can be completed even if lines are multiplexed, thereby improving data communication reliability.

In an example, microcontrollers in function modules at different positions of a tool can communicate and mate with each other. However, in the presence of relatively many nodes, that is, relatively many function modules, if communication determination is not performed on a state of transmission lines, a data conflict occurs, resulting in a great increase of a packet loss rate.

In an example, a busy and idle indication signal indicating a busy or idle state of the transmission lines in the communication system may be preset, such as a digital level signal. Different level states can indicate a busy state and an idle state of the transmission lines. The busy or idle state refers to whether communication data is transmitted on the transmission lines. For example, when the transmission lines change from transmitting data to transmitting no data, an edge of a level signal change may be defined as an idle interrupt edge, and the opposite is defined as a busy interrupt edge. That is to say, a microcontroller may determine a change of the busy or idle state of the transmission lines according to a change situation of the interrupt edge. Then, the microcontroller may determine, according to determination times of different nodes, a target node for currently sending data and control the target node to send the communication data.

That is to say, all nodes in the communication system may determine the busy or idle state of the transmission lines. However, determination is performed at earlier or later times. A node that performs determination first may preferentially send communication data when a determination result determines that the transmission lines are in the idle state. In an example, a node with a long determination time continues the determination until the busy interrupt edge is detected by a node with a shortest time during data sending. In an example, a node waiting for a long time performs the determination for a short time, which can ensure that data of all the nodes can be sent.

In an example, after a node sends data, a current task may be recorded as being completed, and the next time of sending is started. Before the next time of data sending, data may be packaged after a corresponding time is waited for according to a sending time interval, and the packaged data is used as data to be sent after the busy or idle state is determined next time.

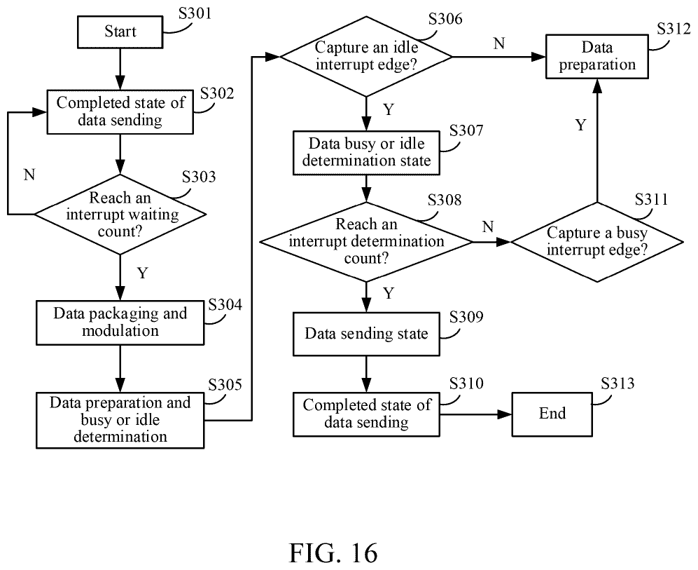

As shown in FIG. 16, a process of the nodes in the communication system determining the busy or idle state of the transmission lines and sending data includes the steps below.

In S301, the process starts.

In S302, data sending is in a completed state.

After data is sent, a current state of a node may be marked as a completed state of data sending.

In S303, it is determined whether an interrupt waiting count is reached. If so, S304 is performed. Otherwise, S302 is returned to.

In S304, data is packaged and modulated.

In S305, data is prepared for busy or idle determination.

In S306, the idle interrupt edge is captured. If so, S307 is performed. Otherwise, S312 is performed.

In S307, data is in in a state of busy or idle determination.

In S308, it is determined whether an interrupt determination count is reached. If so, S309 is performed. Otherwise, S311 is performed.

In S309, data is being sent.

In S310, data sending is in the completed state.

In S311, the busy interrupt edge is captured. If so, S312 is performed.

In S312, data preparation is performed.

In S313, the process ends.

In an example, a tool system may include different types of power tools and different types of battery packs. The power tools may include garden tools such as a mower, a snow thrower, a string trimmer, and a blower, hand-held power tools such as a grinder, a hammer drill, and a circular saw, other auxiliary power tools such as a lighting device, and any power tool that can adopt the solution. A nominal voltage of the battery packs may be 12 V, 24 V, 56 V, 120 V, or the like. The battery packs can output a working current less than or equal to 150 amps (A). In an example, the battery packs can output a current less than 150 A to the power tools.

In this example, function modules inside each power tool can perform carrier communication in the manner of the preceding examples. If power transmission can be performed between different power tools, these power tools may transmit communication data in the carrier communication manner disclosed in the present application.

In an example, when power transmission is performed between a battery pack and a charger, the battery pack and the charger may transmit communication data in the carrier communication manner disclosed in the examples of the present application.

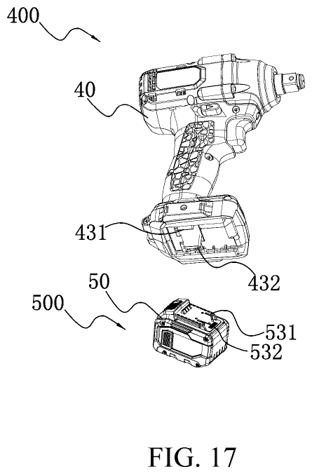

Referring to FIG. 17, a power tool system includes a power tool 400 and a battery pack 500. In this example, the power tool 400 is a hand-held tool for example, and the battery pack 500 is a 56 V battery pack for example.

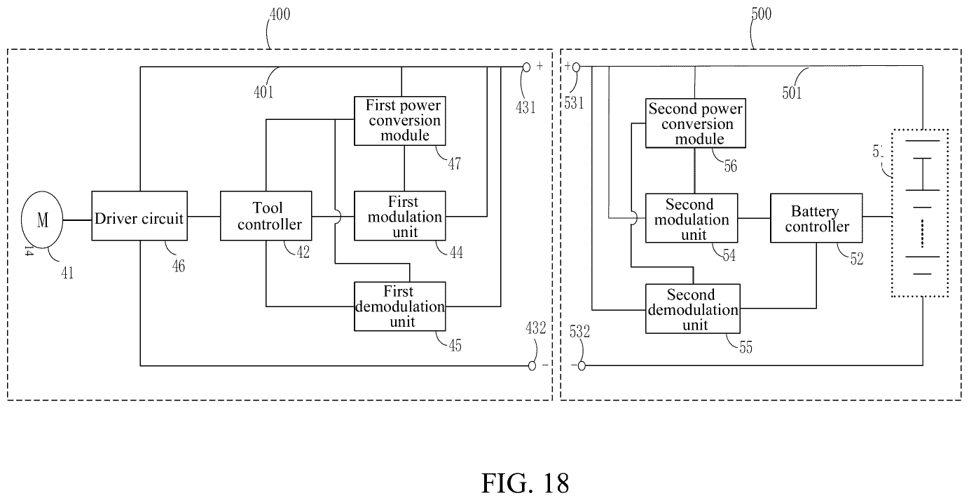

As shown in FIGS. 17 and 18, the power tool 400 includes at least a housing 40, a motor 41, a tool controller 42, tool power terminals 43, a first modulation unit 44, a first demodulation unit 45, and a driver circuit 46. The motor 41 is disposed in the housing 40 and can provide a driving force for the power tool 400. The motor 41 may be a sensored motor or a sensorless motor. The tool power terminals 43 can be electrically connected to battery power terminals 53 in the battery pack 500, and the tool power terminals 43 may include a positive terminal 431 and a negative terminal 432. The driver circuit 46 is electrically connected to stator windings of the motor 41 and can transmit a current from the battery pack 500 to the stator windings to drive the motor 41 to rotate.

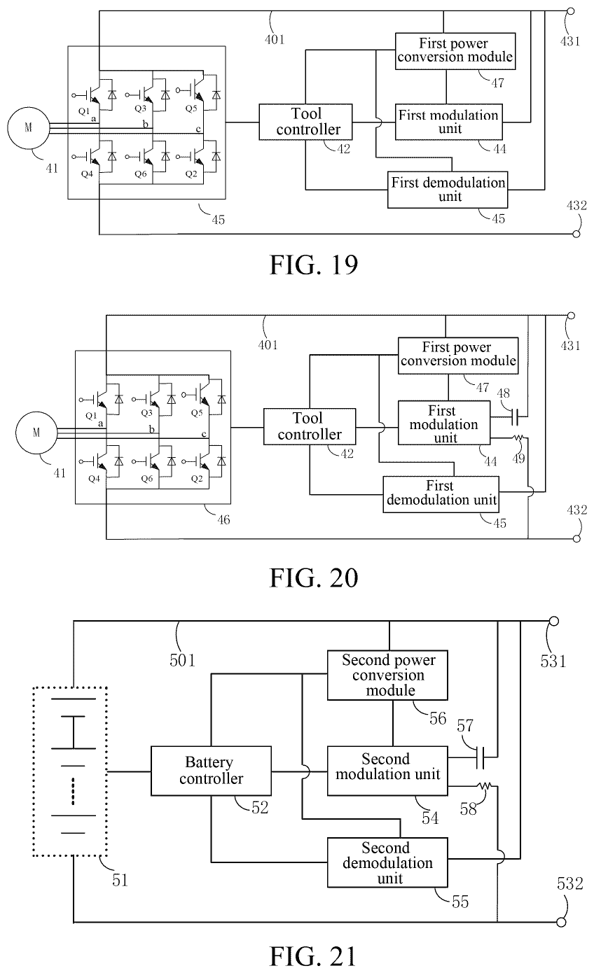

In an example, as shown in FIG. 19, the driver circuit 46 includes multiple switch elements Q1, Q2, Q3, Q4, Q5, and Q6. A gate terminal of each switch element is electrically connected to the tool controller 42 and used for receiving a control signal from the tool controller 42, where the control signal may be a PWM signal. A drain or source of each switch element is connected to a stator winding A, B, or C of the motor 41. The switch elements Q1 to Q6 receive control signals from the tool controller 42 to change their respective conduction states, thereby changing the current loaded by the battery pack 500 to the stator windings A, B, and C of the motor 41. In an example, the driver circuit 46 may be a three-phase bridge driver circuit including six controllable semiconductor power devices (such as field-effect transistors (FETs), bipolar junction transistors (BJTs), and insulated-gate bipolar transistors (IGBTs)). It is to be understood that the preceding switch elements may be any other types of solid-state switches, such as the IGBTs or the BJTs.

To drive the motor 41 to rotate, the driver circuit 46 has multiple driving states, and the motor 41 may have different rotational speeds or different directions of rotation in different driving states. In the present application, a process is not described in detail where the tool controller 42 controls the driver circuit 46 to change different driving states so that the motor 41 obtains different rotational speeds or different directions of rotation.

The battery pack 500 includes at least a housing 50, a cell group 51, a battery controller 52, the battery power terminals 53, a second modulation unit 54, and a second demodulation unit 55. The battery pack 500 may include one or more cell groups. The cell group 51 may include multiple battery cells connected in series and/or in parallel. The battery cells are made of any one of lithium iron phosphate, lithium ternary, or other materials.

In this example, the tool power terminals 43 and the battery power terminals 53 are adaptable to transmit power. The battery power terminals 53 may include a positive terminal 531 and a negative terminal 532. In an example, the tool power terminals 43 may be conductive connectors or metal holders, and the corresponding battery power terminals 53 may be the metal holders or the conductive connectors so that the conductive connectors can be inserted into the metal holders, so as to establish a current transmission path between the power tool 400 and the battery pack 500.

Referring to FIG. 18, the power tool 400 further includes a first power conversion module 47 that can convert high-voltage input power from the tool power terminals 43 into low-voltage power to supply power to the tool controller 42, the first modulation unit 44, or the first demodulation unit 45. For example, the first power conversion module 47 can output electricity of 3.3 V or 5 V. In an example, the battery pack 500 may include a second power conversion module 56 that can supply power to the battery controller 52, the second modulation unit 54, or the second demodulation unit 55.

In this example, communication links that can separately transmit communication data are not included between the power tool 400 and the battery pack 500. To implement data exchange between the power tool 400 and the battery pack 500, battery pack data or tool control data may be coupled to power terminals to be transmitted in a carrier communication manner. However, in this manner, relatively great interference is caused to the transmission of the communication data under complex working conditions of the tool or when a large current is applied to a bus connected to the power terminals.

To solve the preceding problem, a modulation or demodulation module may be provided in at least one of the power tool 400 and the battery pack 500 in the present application. Data modulation before the communication data is coupled onto the power terminals or the bus can avoid relatively great interference occurring when the communication data is directly coupled onto the power terminals or the bus.

In this example, the first modulation unit 44 in the power tool 400 is electrically connected to the tool controller 42 and can receive first communication data output from the tool controller 42 and perform signal modulation on the data to obtain a first modulation signal. The first communication data may include a tool parameter of the power tool 400 or an electrical parameter related to the motor 41. The first modulation signal obtained after modulation may be coupled to the tool power terminals 43. Since the tool power terminals 43 are electrically connected to a bus 401 of a control circuit in the tool, the first modulation signal being coupled to the tool power terminals may be understood as that the first modulation signal can be coupled to any node on the bus 401. Therefore, the tool power terminals 43 may transmit an electrical signal coupled with the first modulation signal to the battery pack 500 through the battery power terminals 53 electrically connected to the tool power terminals 43. The second demodulation unit 55 in the battery pack 500 may demodulate the received first modulation signal to obtain the first communication data transmitted by the power tool 400.

The first demodulation unit 45 in the power tool 400 may be connected to the bus 401 connected to the tool power terminals 43 and can receive an electrical signal coupled with a second modulation signal. The first demodulation unit 45 may demodulate the received second modulation signal to obtain second communication data transmitted by the battery pack 500 and transmit the second communication data to the tool controller 42. The tool controller 42 may adjust output control signals according to the received second communication data to control the driver circuit 46 to change a rotational state of the motor 41. The second communication data may be battery pack data, for example, remaining power of the battery pack, a nominal low voltage of the battery pack, rated power of the battery pack, and an output current of the battery pack. The second modulation signal may be a data signal obtained after modulation of the second communication data in the battery pack 500.

In an example, as shown in FIG. 20, a first anti-interference element 48 and a second anti-interference element 49 are connected in parallel to an output end of the first modulation unit 44. That is to say, the first modulation signal output from the first modulation unit 44 passes through the first anti-interference element 48 and the second anti-interference element 49 and then is coupled onto the bus 401. In an example, the first anti-interference element 48 may be a Y capacitor and can filter first power interference of the first modulation signal; and the second anti-interference element 49 may be an inductor element and can eliminate second power interference of the first modulation signal. The first power interference may be the same as or different from the second power interference. The so-called power interference may include common-mode interference, ground wire interference, and the like.

In an example, an input end of the first demodulation unit 45 may be connected to an anti-interference element, such as a Y capacitor and an inductor element connected in parallel or other anti-interference elements.

In an example, the second modulation unit 54 in the battery pack 500 may be connected to a bus 501 connected to the battery power terminals 53 and can receive the second communication data output from the battery controller 52 and perform signal modulation on the data to obtain the second modulation signal. The second modulation signal obtained after modulation may be coupled onto the bus 501 connected to the battery power terminals 53. Therefore, the battery power terminals 53 may transmit an electrical signal coupled with the second modulation signal to the power tool 400 through the tool power terminals 43 connected to the battery power terminals 53.

The second demodulation unit 55 may demodulate the received first modulation signal to obtain the first communication data transmitted by the power tool 400 and transmit the communication data to the battery controller 52. The battery controller 52 may adjust, according to the received first communication data, a discharge state or a discharge parameter of the cell group 51, for example, a magnitude of an output current, a magnitude of an output voltage, a frequency of the output current, or power of output electrical energy.

In an example, as shown in FIG. 21, a third anti-interference element 57 and a fourth anti-interference element 58 are connected in parallel to an output end of the second modulation unit 54. That is to say, the second modulation signal output from the second modulation unit 54 passes through the third anti-interference element 57 and the fourth anti-interference element 58 and then is coupled onto the bus 501. In an example, the third anti-interference element 57 may be a Y capacitor and can filter first power interference of the second modulation signal output from the second modulation unit 54; and the fourth anti-interference element 58 may be an inductor element and can eliminate second power interference of the second modulation signal. The first power interference may be the same as or different from the second power interference. The so-called power interference may include the common-mode interference, the ground wire interference, and the like.

In an example, an input end of the second demodulation unit 55 may be connected to an anti-interference element, such as a Y capacitor and an inductor element connected in parallel or other anti-interference elements.

In the examples of the present application, a signal modulation manner of the first modulation unit 44 or the second modulation unit 54 is not limited, and a signal demodulation manner of the first demodulation unit 45 or the second demodulation unit 55 is also not limited. The signal modulation manner of the first modulation unit 44 matches with the demodulation manner of the second demodulation unit 55, and the signal modulation manner of the second modulation unit 54 matches with the demodulation manner of the first demodulation unit 45. In an example, at least one of the first modulation unit 44 and the second modulation unit 54 may adopt a binary on-off keying (OOK) modulation manner.

In an example, the first modulation unit 44 may include two input ends that can receive the PWM signal and the first communication data, and the output end of the first modulation unit 44 can output the first modulation signal. The input end of the first demodulation unit 45 can receive the second modulation signal, and an output end of the first demodulation unit 45 can output the second communication data. The second modulation unit 54 may also include two input ends that can receive the PWM signal and the second communication data, and the output end of the second modulation unit 54 can output the second modulation signal. The input end of the second demodulation unit 55 can receive the first modulation signal, and an output end of the second demodulation unit 55 can output the first communication data.

In an example, the first modulation unit 44 and the first demodulation unit 45 may be separate function modules independently disposed or may be a function module that integrates modulation and demodulation functions. The second modulation unit 54 and the second demodulation unit 55 may be separate function modules independently disposed or may be a function module that integrates modulation and demodulation functions.

What is claimed is:

1. A power tool, comprising:
transmission lines capable of transmitting power and a communication data; and
a plurality of function modules comprising at least an operation module and drive motor electrically connected to the transmission lines;
wherein the plurality of function modules are capable of selectively receiving the communication data from the transmission lines or transmitting the communication data to the transmission lines and a transmission frequency at which the transmission lines transmit the communication data is greater than or equal to 1 kilohertz (kHz).

2. The power tool of claim 1, wherein the transmission frequency at which the transmission lines transmit the communication data is greater than or equal to 10 kHz.

3. The power tool of claim 1, wherein a function module of the plurality of function modules comprises a microcontroller having a data port for sending or receiving the communication data.

4. The power tool of claim 3, wherein the function module further comprises a serial communication unit connected to the data port of the microcontroller and configured to serially receive or send the communication data.

5. The power tool of claim 4, wherein the function module further comprises a coupling element connected between the serial communication unit and the transmission lines and capable of coupling the communication data output from the function module onto the transmission lines and a decoupling element connected to the transmission lines and capable of decoupling the communication data on the transmission lines so that the function module obtains power.

6. The power tool of claim 3, wherein the function module further comprises a modulation unit connected to the transmission lines and capable of modulating the communication data output from the function module or demodulating the communication data received by the function module.

7. The power tool of claim 3, wherein the transmission lines are a pair of power lines and the microcontroller is configured to, after receiving the communication data transmitted on the pair of power lines, perform anti-interference on the communication data.

8. The power tool of claim 1, wherein the plurality of function modules further comprises a control unit.

9. A power tool, comprising:
a main body comprising a working assembly and a control unit;
an operation device connected to the main body and having an operation module for generating an operation instruction;
a power module configured to provide a power source for the power tool;
a drive motor configured to provide a driving force for the power tool; and
transmission lines capable of transmitting power and a communication data;
wherein the control unit, the operation module, the power module, and the drive motor are each electrically connected to the transmission lines and capable of selectively receiving the communication data from the transmission lines or transmitting the communication data to the transmission lines.

10. The power tool of claim 9, wherein a transmission frequency at which the transmission lines transmit the communication data is greater than or equal to 10 kHz.

11. The power tool of claim 9, wherein a function module of the plurality of function modules comprises a microcontroller having a data port for sending or receiving the communication data.

12. The power tool of claim 11, wherein the function module further comprises a serial communication unit connected to the data port of the microcontroller and configured to serially receive or send the communication data.

13. The power tool of claim 12, wherein the function module further comprises a coupling element connected between the serial communication unit and the transmission lines and capable of coupling the communication data output from the function module onto the transmission lines and a decoupling element connected to the transmission lines and capable of decoupling the communication data on the transmission lines so that the function module obtains power.

14. The power tool of claim 11, wherein the function module further comprises a modulation unit connected to the transmission lines and capable of modulating the communication data output from the function module or demodulating the communication data received by the function module.

15. The power tool of claim 11, wherein the transmission lines are a pair of power lines and the microcontroller is configured to, after receiving the communication data transmitted on the pair of power lines, perform anti-interference on the communication data.

16. A mower, comprising:
a main body comprising a control unit, a cutting assembly, and a walking assembly, wherein the cutting assembly is configured to cut vegetation and the walking assembly is configured to drive the mower to walk;
a first drive motor configured to drive the cutting assembly to perform mowing;
a second drive motor configured to drive the walking assembly to walk;
a handle device connectable to the main body and having an operation module capable of generating an operation instruction;
a power module configured to provide a power source for the mower; and
transmission lines capable of transmitting power and a communication data;
wherein the control unit, the first drive motor, the second drive motor, the operation module, and the power module are each electrically connected to the transmission lines and capable of selectively receiving the communication data from the transmission lines or transmitting the communication data to the transmission lines.

17. The mower of claim 16, wherein a function module of the plurality of function modules comprises a microcontroller having a data port for sending or receiving the communication data.

18. The mower of claim 17, wherein the function module further comprises a serial communication unit connected to the data port of the microcontroller and configured to serially receive or send the communication data.

19. The mower of claim 18, wherein the function module further comprises a coupling element connected between the serial communication unit and the transmission lines and capable of coupling the communication data output from the function module onto the transmission lines and a decoupling element connected to the transmission lines and capable of decoupling the communication data on the transmission lines so that the function module obtains power.

20. The mower of claim 17, wherein the transmission lines are a pair of power lines and the microcontroller is configured to, after receiving the communication data transmitted on the pair of power lines, perform anti-interference on the communication data.
